(19) United States
(12) Patent Application Publication
(10) Pub. No.: US 2019/0179635 A1
(43) Pub. Date: Jun. 13, 2019

(54) METHOD AND APPARATUS FOR TENSOR AND CONVOLUTION OPERATIONS

(71) Applicant: FUTUREWEI TECHNOLOGIES, INC., Plano, TX (US)

(72) Inventors: Guofang Jiao, San Diego, CA (US); Zhou Hong, Cupertino, CA (US); Chengkun Sun, San Diego, CA (US)

(73) Assignee: FUTUREWEI TECHNOLOGIES, INC., Plano, TX (US)

(21) Appl. No.: 15/837,287

(22) Filed: Dec. 11, 2017

(51) Int. Cl. G06F 9/30; G06F 17/16; G06F 17/15; G06F 7/52

(52) U.S. Cl. CPC G06F 9/3001; G06F 17/16; G06N 3/02; G06F 7/52; G06F 17/153

(57) ABSTRACT

Aspects of the disclosure provide a circuit that includes a processing circuit, a memory directly coupled to the processing circuit via a dedicated data bus and a control circuit. The processing circuit includes a dot product engine. The dot product engine is configured to perform, in response to an instruction, an operation that includes dot product calculations on a weight input and a pixel sample input, and to store a result of the operation into the memory. The control circuit is configured to control the dot product engine to perform arithmetic operations that include the dot product calculations, and control the dot product engine to perform an accumulation of outputs of the dot product calculations and data received from the memory via the dedicated data bus to generate the result of the operation.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Artificial intelligence is used in various, applications, such as image recognition, speech recognition and translation, vehicle identification, pedestrian identification, landmark identification, and the like. One of the tools in, artificial intelligence is neural network, such as convolutional neural network (CNN), deep neural network (DNN), and the like. Neural network can heavily rely on tensor operations and convolution operations.

### SUMMARY

Aspects of the disclosure provide a circuit that includes a processing circuit, a memory directly coupled to the processing circuit via a dedicated data bus and a control circuit. The processing circuit includes a dot product engine. The dot product engine is configured to perform, in response to an instruction, an operation that includes dot product calculations on a weight input and a pixel sample input, and to store a result of the operation into the memory. The control circuit is configured to control the dot product engine to perform arithmetic operations that include the dot product calculations, and control the dot product engine to perform an accumulation of outputs of the dot product calculations and data received from the memory via the dedicated data bus to generate the result of the operation.

Optionally, in any of the preceding aspects, another implementation of the aspect provides that the control circuit is configured to control the dot product engine to perform the accumulation of the outputs of the dot product calculations and the data received from the memory in response to at least one, of a convolution application programing interface (API) instruction and a matrix multiplication API instruction.

Optionally, in any of the preceding aspects, another implementation of the aspect provides that the dot product engine is configured to perform, in response to a texture filtering instruction, dot product calculations on weights and pixel samples of four dimensions for bilinear filtering.

Optionally, in any of the preceding aspects, another implementation of the aspect provides that the control circuit is configured to control the memory to provide at least one of the weights and the pixel samples.

Optionally, in any of the preceding aspects, another implementation of the aspect provides that the processing circuit further includes a weight circuit configured to provide the weights to the dot product engine, and a texture cache configured to provide the pixel samples to the dot product engine. The control circuit is configured to load the weights to the weight circuit from at least one of the texture cache and the memory.

Optionally, in any of the preceding aspects, another implementation of the aspect provides that the dot product engine includes at least a dot product circuit configured to calculate a dot product of four or less dimensions.

Optionally, in any of the preceding aspects, another implementation of the aspect provides that the control circuit is configured to control the weights, the pixel samples and the outputs of the dot product engine to have a first input-output correspondence configuration in response to a convolution instruction, and have a second input-output correspondence configuration in response to a matrix multiplication instruction.

Optionally, in any of the preceding aspects, another implementation of the aspect provides that the control circuit is configured to, have the weights, the pixel samples and the outputs shuffled according to a first input-output correspondence configuration in response to a convolution instruction, and to have the weights, the pixel samples, and the outputs shuffled according to a second input-output correspondence configuration in response to a matrix multiplication instruction.

Optionally, in any of the preceding aspects, another implementation of the aspect provides that the memory comprises memory interface circuits that are directly coupled to interface circuits of the processing circuit via wire interconnections.

Aspects of the disclosure provide a method that includes performing, by a processing circuit including a dot product engine, in response to a first instruction, a first operation that includes dot product calculations, storing a result of the first operation in a memory that is directly coupled to the processing circuit via a dedicated data bus, providing, from the memory, the result as an input to the processing circuit, in response to a second instruction, and performing, by the processing circuit, a second operation that includes dot product calculations and an accumulation of outputs of the dot product calculations and the input from the memory.

Aspects of the disclosure provide a graphics processing unit that includes a shader processor, a memory, and a texture processor. The shader processor configured to receive a plurality of instructions, and schedule the instructions for operations. The texture processor is directly coupled to the memory via a dedicated data bus. The texture processor includes a dot product engine configured to perform, in response to an instruction, an operation that includes dot product calculations on a weight input and a texture input, and store a result of the operation into the memory. The texture processor also includes a control circuit configured to control the dot product engine to perform arithmetic operations that include the dot product calculations and control the dot product engine to perform an accumulation of outputs of the dot product calculations and data received from the memory via the dedicated data bus.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a block diagram of an electronic device 100 according to an embodiment of the disclosure;

FIG. 2 shows a flow chart outlining a process 200 according to an embodiment of the disclosure;

FIG. 3 shows a diagram of an input-output correspondence configuration 300 for a convolution instruction according to an embodiment of the disclosure;

FIG. 4 shows a flow chart outlining a process example 400 according to an embodiment of the disclosure;

FIG. 5 shows a diagram of an input-output correspondence configuration 500 for a matrix multiplication instruction according to an embodiment of the disclosure;

FIG. 6 shows a diagram of an input-output correspondence configuration 600 for a matrix multiplication instruction according to an embodiment of the disclosure;

FIG. 7 shows a flow chart outlining a process example 700 according to an embodiment of the disclosure;

FIG. 8 shows a flow chart outlining a process example 800 according to an embodiment of the disclosure;

FIG. 9 shows a flow chart outlining a process example 900 according to an embodiment of the disclosure; and

FIG. 10 shows a flow chart outlining a process example 1000 according to an embodiment of the disclosure.

### DETAILED DESCRIPTION OF EMBODIMENTS

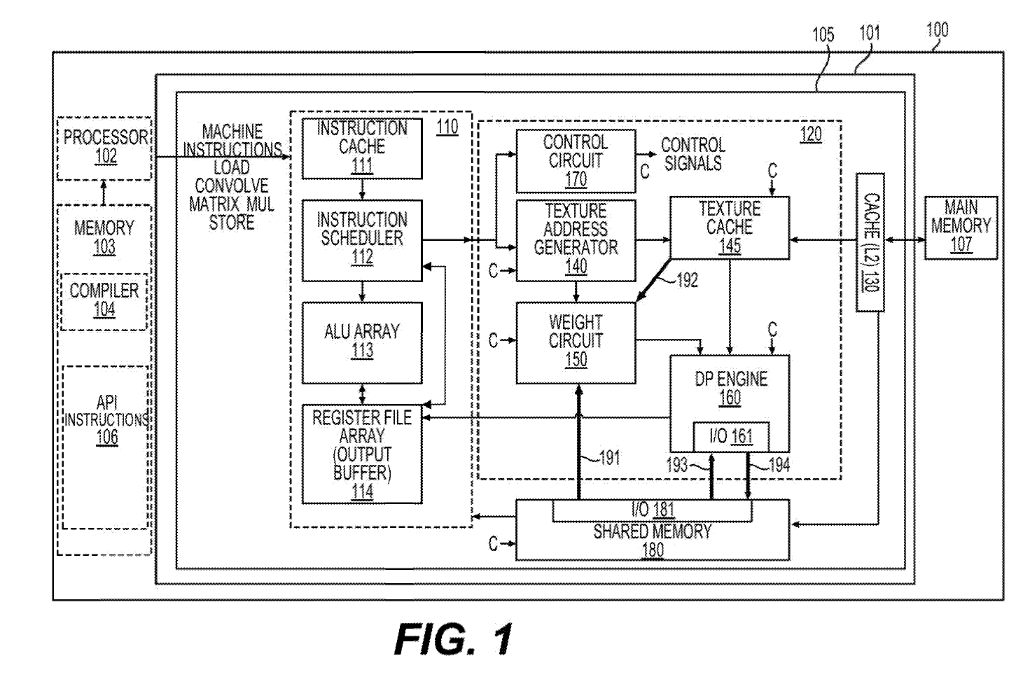

FIG. 1 shows a block diagram of an electronic device 100 according to an embodiment of the disclosure. The electronic device 100 includes a graphics processing unit (GPU) 105. The GPU 105 includes a texture processor 120 that is configured to perform tensor operations and convolution operations in addition to texture filtering operations. In an example, the texture processor 120 includes a dot product (DP) engine 160 that is customized for performing dot product calculations. The texture processor 120 is configured to use the DP engine 160 to perform dot product calculations in the texturing filtering operations, in the convolution operations and in the tensor operations. The architecture of the GPU 105 and the texture processor 120 will be discussed in, detail further herein.

The electronic device 100 can be any suitable device, such as a smart phone, a tablet computer, a laptop computer, a desktop computer, a server device, a camera, a video recorder, a game console and the like that includes a graphic processing unit. According to an aspect of the disclosure, the electronic device 100 executes one or more applications that use artificial intelligence technology, and thus performs convolution operations and tensor operations (e.g., matrix multiplication operations).

Generally, the electronic device 100 includes computation resources, such as a central processing unit (CPU), a general arithmetic-logic unit (ALU), and the like that can be configured to perform arithmetic operations (such as addition of numbers, multiplication of numbers, and the like) in convolution operations and tensor operations. According to an aspect of the disclosure, the texture processor 120 in the GPU 105 is configured to perform convolution operations and tensor operations in an accelerated manner, thus the electronic device 100 can assign at least a portion of the computation workload to the texture processor 120 to improve performance.

It is noted that the electronic device 100 includes other suitable components, such as a central processing unit (CPU), analog circuits, mixed-signal circuits, radio frequency circuits, digital circuits, memory circuits that are not shown in FIG. 1, and those components are suitably coupled with the GPU 105. In an embodiment, the GPU 105 is a component of a system on chip (SOC) 101. The SOC 101 includes other suitable components, such as a CPU, a static random access memory (SRAM) module, a flash memory module, and the like. The SOC 101 is suitably coupled with other chips, such as dynamic random access memory (DRAM) chips, and the like. In another embodiment, the GPU 105 is on a separate chip from other components, such as a multiple-core processor chip, DRAM chips and the like.

The texture processor 120 is configured to operate in response to instructions that are in a machine language, for example in binary. An instruction in the machine language is referred to as a machine instruction. According to an aspect of the disclosure, the texture processor 120 is configured to perform a matrix multiplication or a convolution of a specific size in response to a suitable machine instruction, and is configured to perform a matrix multiplication or a convolution operation of any suitable size in response to a plurality of machine instructions. For example, the texture processor 120 is configured to perform a convolution that uses a 2×2 grid of convolution coefficients in response to a convolution machine instruction and is configured to perform a 4×4 matrix multiplication in response to a matrix multiplication machine instruction.

In an embodiment, a matrix multiplication (or a convolution) of a larger size than the specific size is split to multiple matrix multiplication operations (or multiple convolution operations) of the specific size. In an example, a high level programming language (e.g., Java, C++, and the like) uses application programing interface (API) that is easier for programmers to develop computer programs. The API includes a set of API instructions for building application software. In the example, the API includes one or more API convolution instructions, API matrix multiplication instructions and the like. In an example, an API matrix multiplication instruction can be compiled to generate a plurality of machine instructions that are executable by the GPU 105.

In the FIG. 1 example, the electronic device 100 includes a processor 102 and a memory 103. The memory 103 stores software instructions 104 of a compiler. The processor 102 can execute the software instructions 104 to compile the APE instructions in the high level programming language, and generate machine instructions that are executable by the GPU 105. In an example, the processor 102 can generate a first mix of data transfer instructions (e.g., load instructions, store instructions) and matrix multiplication machine instructions in response to a matrix multiplication API instruction of a larger size than the specific size, in an embodiment, the texture processor 120 executes the first mix of machine instructions, stores intermediate results in a memory (e.g., shared memory), generates a final result for the first mix of machine instructions, and outputs the final result.

In another example, the processor 102 can generate a second mix of data transfer instructions (e.g., load instructions, store instructions) and convolution machine instructions in response to a convolution API instruction of a larger size than the specific size. In an embodiment, the texture processor 120 executes the second mix of machine instructions, stores intermediate results in a memory (e.g., a shared memory), generates a final result for the second mix of machine instructions, and outputs the final result.

It is noted that, in an example, the API instructions in the high level programing language are compiled by a processor that is external to the electronic device 100. The machine instructions can be suitably stored and input into the electronic device 100.

In the FIG. 1 example, the GPU 105 includes a shader processor 110 and the texture processor 120 coupled together. The shader processor 110 is configured to perform graphics operations such as shading, lighting, shadowing, and the like.

According to an aspect of the disclosure, the electronic device 100 includes a memory system of various memories to assist the operations of processors, such as the shader processor 110 and the texture processor 120. In the FIG. 1 example, the electronic device 100 includes a main memory 107 that is external to the GPU 105, a cache 130, a shared memory 180 and registers within the GPU 105. In an example, the main memory 107 is the primary memory for processors, such as the GPU 105, the processor 102 and the like in the electronic device 100. Generally, the main memory 107 is relatively large and provides a vast majority of the memory during an, execution of a software program. The space allocation and usage in the main memory 107 has a lifetime of the execution of the software program (or until a free instruction for the main memory is called). In an example, the main memory 107 includes one or more DRAM chips. The main memory 107 has a relatively large latency, the usage of the cache 130 and the shared memory 180 improves memory access speed.

The cache 130 acts as a buffer between the main memory 107 and processors in the GPU 105, such as the texture processor 120 and the shader processor 110. The cache 130 can reduce memory access to the main memory 107 and can reduce memory access latency. The cache 130 has much smaller memory space than the main memory 107, and stores copies of the data from frequently used locations in the main memory 107. In an, example, the cache 130 is implemented using SRAM that has faster speed than DRAM. In an embodiment, the cache 130 is level 2 (L2) cache, and the GPU 105 can include other cache, such as level 1 (L1) cache that is closer to the processors, and has faster access speed.

The shared memory 180 is implemented using SRAM. In an embodiment, the shared memory 180 is optimized to have faster speed than the cache 130. For example, SRAM cells in the shared memory 180 are optimized (e.g., with larger cell area) to reduce access latency while the SRAM cells in the cache 130 are optimized to reduce silicon area. In an example, the shared memory 180 is also placed closer to the processors in the GPU 105, such, as the texture processor 120 and the shader processor 110 than the cache 130. Further, in an example, the shared memory 180 is configured to have a relatively higher bandwidth. Thus, the shared memory 180 has faster memory access speed than the cache 130 in an example.

According to an aspect of the disclosure, the shared memory 180 is coupled to the texture processor 420 to enable intra-thread. and inter-thread data communication for convolution operations and/or matrix multiplication operations to improve efficiency, which will be discussed in detail further herein. In a related example, a texture processor is not directly coupled to a shared memory, thus the texture processor outputs the result of each operation to a shader processor that is coupled to the shared memory.

In the FIG. 1 example, the shader processor 110 includes an instruction cache 111, an instruction scheduler 112, an ALU array 113 and a register file array 114 coupled together as shown. The texture processor 120 includes, a texture address generator 140, a texture cache 145, a weight circuit 150, a dot product (DP) engine 160, and a control circuit 170 coupled together as shown in FIG. 1. The texture processor 120 is directly coupled to the shared memory 180.

The instruction cache 111 is configured to receive machine instructions, such as texture filtering machine instructions, convolution machine instructions, matrix multiplication machine instructions, load machine instructions, and the like. In an embodiment, the instruction cache 111 is L1 cache.

The instruction scheduler 112 is configured to manage execution of machine instructions. The instruction scheduler 112 fetches the machine instructions for each thread from an instruction cache 111, decodes each machine instruction, and performs flow control for the thread. The instruction scheduler 112 selects active threads for execution and checks for read/write port conflict among the selected threads. When there is no conflict, the instruction scheduler 112 sends machine instructions to the ALU array 113 or the texture Processor 120. The instruction scheduler 112 maintains a program/instruction counter for each thread and updates the counter as machine instructions are executed or program flow is altered. The instruction scheduler 112 also issues requests to fetch missing instructions and removes threads that are completed. According to an aspect of the disclosure, the instruction scheduler 112 can provide texture filtering machine instructions, convolution machine instructions and matrix multiplication machine instructions to the texture processor 120.

The ALU array 113 includes multiple ALUs configured to perform arithmetic and logic operations, such as addition, subtraction, multiplication, multiply and accumulate, absolute, negation, comparison, saturation, AND, OR, XOR, and the like in response to arithmetic, machine instructions. The multiple ALUs can operate in parallel.

The register file array 114 includes multiple register files corresponding to the ALUs. The register file array 114 can buffer intermediate results as well as final results from ALU array 113 and the texture processor 120.

It is noted that the texture processor 120 includes additional data paths, such as data paths 191-194 to assist convolution operations and. matrix multiplication operations. In an embodiment, the data paths includes input/output (I/O) circuits and wire connections that connect the I/O circuits. For example, the shared memory 180 includes I/O circuits 181, and the DP engine 160 includes I/O circuits 161, and the circuits 181 and the I/O circuits 161 are connected by wire connections to form the data paths 193 and 194 in an example. The data path 191 and 192 can be similarly configured. In an example, a Wire connection refers to an electrically conductive trace that transmits electrical signals, such as voltage signal, current signal and the like. In the semiconductor manufacturing, in an example, a wire connection includes patterned metal lines in one or more metal layers and vias that interconnect metal lines in different metal layers. In another embodiment, the data paths are implemented using dedicated data bus. A data bus refers to a communication system that transfers data between components inside an integrated circuit (IC) system, and can include hardware components (e.g., I/O (circuits, wires) and software (e.g., communication protocols).

The texture address generator 140 is configured to receive a scheduled machine instruction, such as a texture filtering machine instruction, a convolution machine instruction, a matrix multiplication machine instruction, a load machine instruction and the like from the instruction scheduler 112 and operate based on the scheduled machine instruction.

In an example, when the machine instruction is a texture filtering machine instruction, the texture filtering machine instruction can specify texture coordinates in a texture space. The texture address generator 140 calculates filtering coefficients (e.g., 4 coefficients for a 2×2 grid) based on fractional parts of the texture coordinates, and provides the filtering, coefficients to the weight circuit 150 as weights. Further, in response to the texture filtering machine instruction, for each pixel, the texture address generator 140 determines positions of pixel samples (e.g., four pixel samples) for filtering, and provides the positions of the pixel samples to the texture cache 145.

In another example, when the machine instruction is a convolution machine instruction (or a matrix multiplication may instruction), the texture address generator 140 is configured to determine memory locations for kernel coefficients for convolution. When the kernel coefficients are in the shared memory 180, the kernel coefficients are loaded to the weight circuit 150 from the shared memory 180 via the data path 191. When the kernel coefficients are not in the shared memory 180, in an example, the kernel coefficients can be loaded from the main memory 107 to the shared memory 180 via the cache 130. In another example, the kernel coefficients can be loaded from the memory 107 to the weight circuit 150 via the cache 130, the texture cache 145 and the data path 192. Further, in response to the convolution machine instruction, for each pixel, the texture address generator 140 determines positions of pixel samples (e.g., four pixel samples) for filtering, and provides the positions of the pixel samples to the texture cache 145.

In an embodiment, the texture address generator 140 is configured to convert a machine instruction into a plurality of atomic instructions. In an example, an atomic instruction is an indivisible and irreducible machine instruction that is executed by specific circuitry in a single operation that is referred to as an atomic operation. In an example, an atomic operation is an operation unit that is either done or not performed, and cannot be half-complete. In an example, the texture address generator 140 is configured to convert, a machine convolution instruction using a kernel of 5×5 into seven atomic convolution instructions that each uses four or less kernel coefficiencies.

In an example, the texture cache 145 receives the positions of the pixel samples from texture address generator 140 and determines whether the pixel samples are stored in the texture cache 145. When the pixel samples are in the texture cache 145, the texture cache 145 provides the pixel samples to the DP engine 160. When the pixel samples are rim in the texture cache 145, the texture cache 145 can perform a cache fill from the main memory 107. After the cache fill, texture cache 145 provides the pixel samples to the DP engine 160.

The weight circuit 150 is configured to receive and hold weights dining an execution, of a machine instruction. In an embodiment, the weight circuit 150 is implemented using register circuit and/or buffer circuit. In an example, the weight circuit 150 receives weights from the texture address generator 140 in response to a texture filtering machine instruction. In another example, kernel coefficients are pre-loaded in the shared memory 180. The shared memory 180 provides suitable kernel coefficients to the weight circuit 150. The weight circuit 150 can perform other suitable functions. In an embodiment, the weight circuit 150 is configured to transpose, for example a weight matrix.

In an embodiment, the dot product (DP) engine 160 includes a plurality of dot product circuits and accumulation circuits. In an example, each of the dot product circuits is configured to compute a dot product of four dimensions. The dot product circuit receives a first input I1 of 4 dimensions and a second input I2 of 4 dimensions, and generates an output P of a scalar value, such as according to Eq. 1:

P=w00×tex00+w01×tex01+w10×tex10+w11×tex11 Eq. 1

where (tex00, tex01, tex10, tex11) form the first input I1, and (w00, w01, w10, w11) form the second input I2. In the example of texture filtering, (tex00, tex01, tex10, tex11) are values of an attribute of the pixel samples (e.g., a row in ARGB matrices), and (w00, w01, w10, w11) are filtering coefficients (e.g., a column in a weight matrix). In the example of convolution, (tex00, tex01, tex10, tex11) are values of the pixel samples (e.g., a row in ARGB matrices), and (w00, w01, w10, w11) are kernel coefficients (e.g., a column in a weight matrix). In the example of matrix multiplication, (tex00, tex01, tex10, tex11) are values in a row of a first matrix, and (w00, w01, w10, w11) are values in a column of a second matrix.

It is noted that while the above example uses dot product circuits that each is configured to compute a dot product of four dimensions, the DP engine 160 can be implemented using any suitable technique. In an example, the DP engine 160 is implemented using dot product circuits that each is configured to compute a dot product of two dimensions. Thus, in an example, a dot product circuit of four dimensions can be replaced by two dot product circuits of two dimensions and a suitable accumulation circuit that is configured to add the results from the two dot product circuits of two dimensions to generate a result of dot product of four dimensions. In texture filtering and separable convolution examples, the equivalent operations may be implemented by using multiple dot product of less dimensions such as calculation on pixel samples with horizontally directional weights first and store their temporary results in shared memory, and then operation on the temporary results with vertically directional weights.

Further, in the embodiment, the output P is provided as a first input to an accumulation circuit. The accumulation circuit adds the first input P with a second input M to generate a result O. In an embodiment, the second input M is provided from the shared memory 180. In an embodiment, the accumulation circuit is configured to have a relatively higher precision.

The DP engine 160 can be controlled to output results to the register file 114 or the shared memory 180.

According to an aspect of the disclosure, the texture processor 120 is configured to have multiple input-output correspondence configurations, such as a first input-output correspondence configuration for convolution, a second input-output correspondence configuration for matrix multiplication.

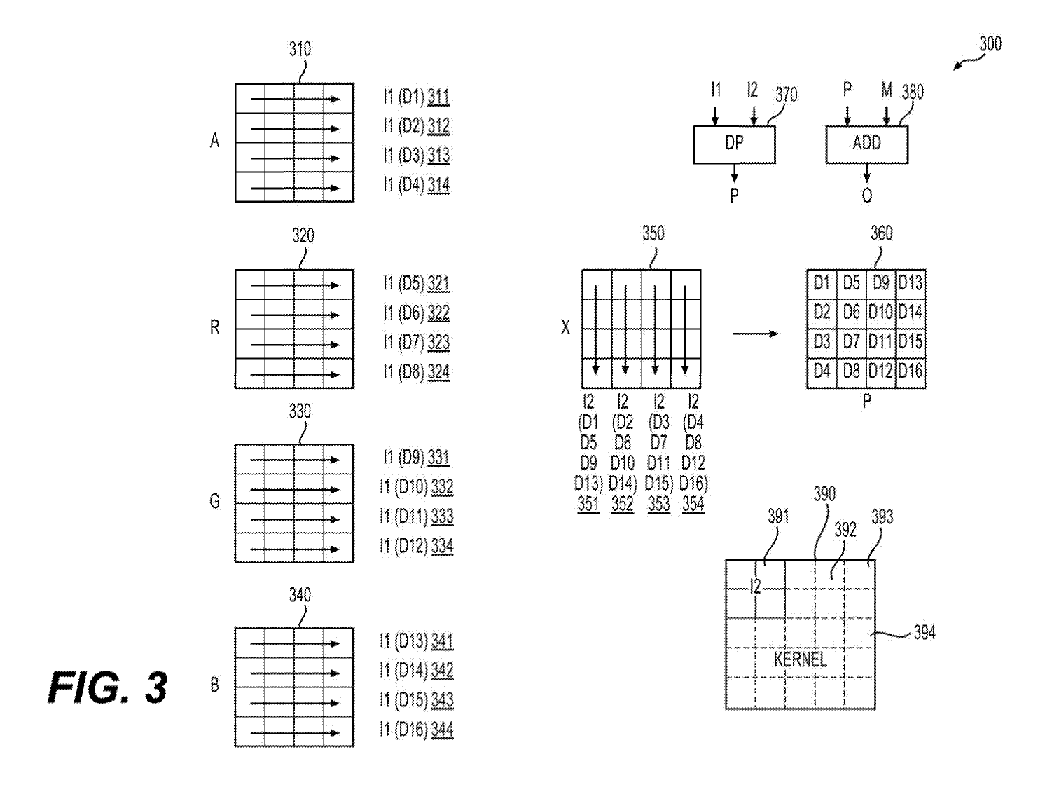

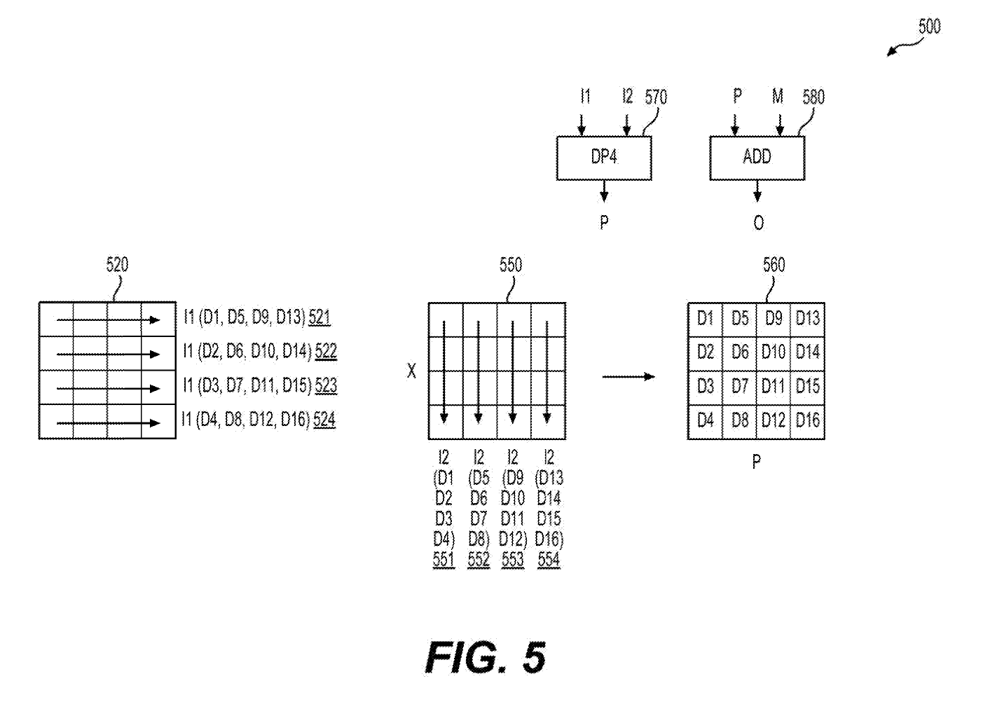

In an embodiment, the dot product engine 160 is wired to have the multiple input-output correspondence configurations. For example, the dot product engine 160 includes multiple dot product circuits that operate in parallel. The inputs to the dot product circuits and the outputs of the dot product circuits are wired to the inputs and outputs of the dot product engine 160 to have the multiple input-output correspondence configurations. In when the machine instruction is a texture filtering machine instruction or a convolution machine instruction, the DP engine 160 is controlled to have the first input-output correspondence configuration that is further discussed with reference to FIG. 3 herein; and when the machine instruction is a matrix plication machine instruction, the DP engine 160 is controlled to have the second input-output correspondence machine configuration that is further discussed with reference to FIG. 5 herein.

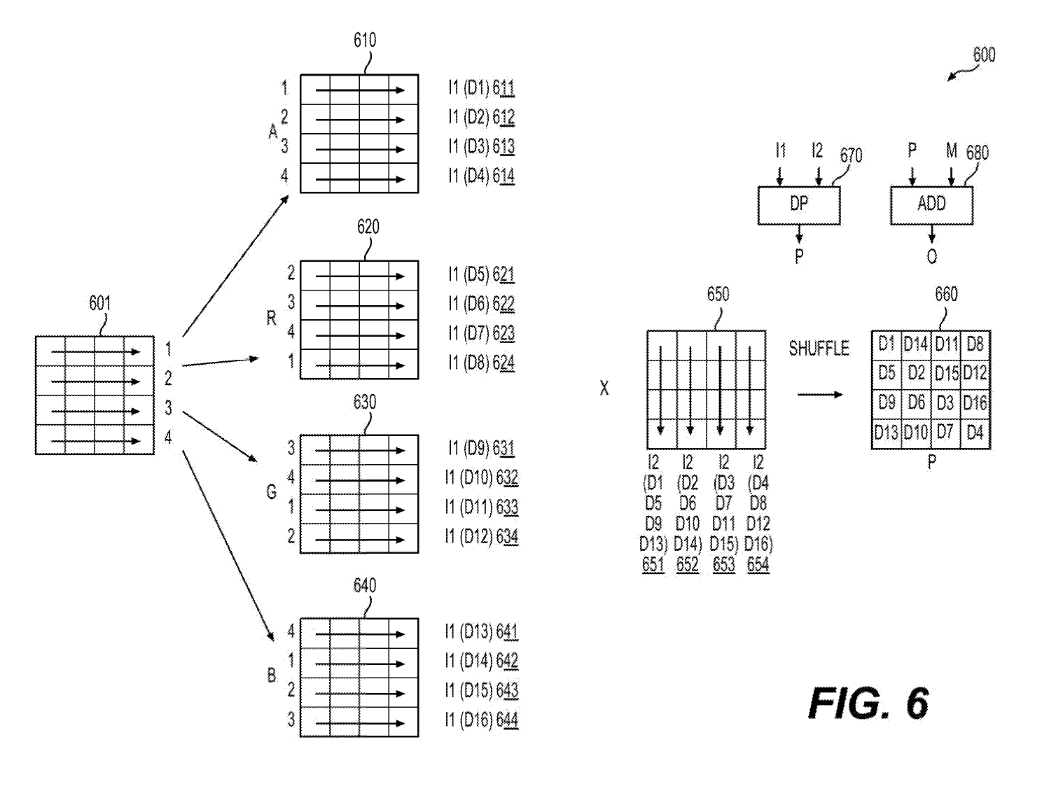

In another embodiment the weight circuit 150, the texture cache 145 and the shared memory 180 are configured to suitably shuffle (re-arranged) data to have the multiple input-output correspondence configurations that are further discussed with reference to FIG. 3 and FIG. 6 herein.

The control circuit 170 is configured to generate control signals C in response to a machine instruction (e.g., a load machine instruction, a convolution machine instruction a matrix multiplication machine instruction, and provides the control signals C to other components, such as the texture address generator 140, the texture cache 145, the weight circuit 150, the configurable DP engine 160, the shared memory 180 and the like to control the ether comonents to operate according to the machine instruction.

In an example, the texture processor 120 receives load machine instruction to load a weight matrix. In an example, the weight matrix is preloaded in the shared memory 180. In response to the load machine instruction, the weight matrix is loaded from the shared memory 180 into the weight circuit 150. In example, the weight matrix is loaded from the main memory 107 via the cache 130, the texture cache 145 and the data path 192 into the weight circuit 150.

In another example, the texture process 120 receives a convolution machine instruction having four parameters. The four parameters are a destination, a weight, a texture and an accumulation. In an example, the weight is indicative of the memory location of the weight matrix. For example, the weight is indicative of convolution kernel attributes, such as kernel size, identifier of a memory device (e.g., the main memory 107, the shared memory 180, or the register file array 114) for storing convolution kernel weight. In an example, the texture is indicative of the memory location of ARGB matrices. For example, the texture is indicative of one or more registers in the register file array 114 where one or more texture coordinates are stored, and the texture coordinates are used to determine pixel samples for texture coordinates. In an example, the accumulation is indicative of the memory location (e.g., in the shared memory 180, temporary registers) of the accumulation input matrix, and the destination is indicative of the memory location (e.g. the shared memory 180, the register tile array 114) of the output matrix. In an example, the texture includes modifier to identify whether the ARGB matrices is in the main memory 107 (and fetched into the texture cache 145), or in the shared memory 180. In an example, the accumulation is fetched from the shared memory 180 or temporary registers, the destination can be the shared memory 180 or the register file array 114. In response to the convolution instruction, the texture processor 120 performs convolution and accumulation based on the weight matrix, the ARGB matrices and the accumulation input matrix to generate the output matrix, and stores the output matrix. The detail operations will be discussed further with reference to FIG. 3 herein.

In another example, the texture processor 120 receives a matrix multiplication machine instruction having four parameters. The four parameters are a destination, a weight, a source and an accumulation. In an example, the weight is indicative of the memory location of a first matrix, the source is indicative of the memory location of a second matrix, the accumulation is indicative of the memory location of the accumulation input matrix, and the destination is indicative of the memory location of the output matrix. In another example, the weight includes a first indicator that is indicative of a starting coordinate of a sub weight matrix relative to an original weight matrix and a second indicator that is indicative of a memory device, and starting address of the original weight matrix in the memory device. Further, the source includes a first indicator that is indicative of a starting coordinate of a sub input matrix relative to an original input matrix and a second indicator that is indicative of a memory device, and starting address of the original input matrix in the memory device. In an example, the source includes modifier to identify whether the second matrix is in the main memory 107 (and fetched into the texture cache 145), or in the shared memory 180. In an example, the accumulation is fetched from the shared memory 180 or temporary registers, the destination is in the shared memory 180. In response to the matrix multiplication instruction, the texture processor 120 performs matrix multiplication and accumulation based on the first matrix, the second matrix and the accumulation input matrix to generate the output, matrix, and stores the output matrix. The detail operations will be discussed further with reference to FIGS. 5 and 6 herein.

In another example, the texture processor 120 receives a store instruction having two parameters. The two parameters are a destination and a result matrix. In an example, the result matrix is indicative of the memory location in the shared memory 180 and the destination is indicative of memory location in the main memory 107.

According to an aspect of the disclosure, in an embodiment, in response to convolution machine instruction or matrix multiplication machine instruction, the texture address generator 140 is bypassed. The control circuit 170 provides the control signal to the weight circuit 150, the texture cache 145, the DP engine 160 and the shared memory 180 to operate according to the machine instruction.

It is noted that, in an embodiment, the texture processor 120 includes multiple DP engines 160 that can operate in parallel. Thus, the throughput of the texture processor 120 can be further increased.

According to an aspect of the disclosure, the DP engine 160 can be configured to perform operations at various precision with different throughputs, such as 8-bit, 12-bit, 16-bit and the like.

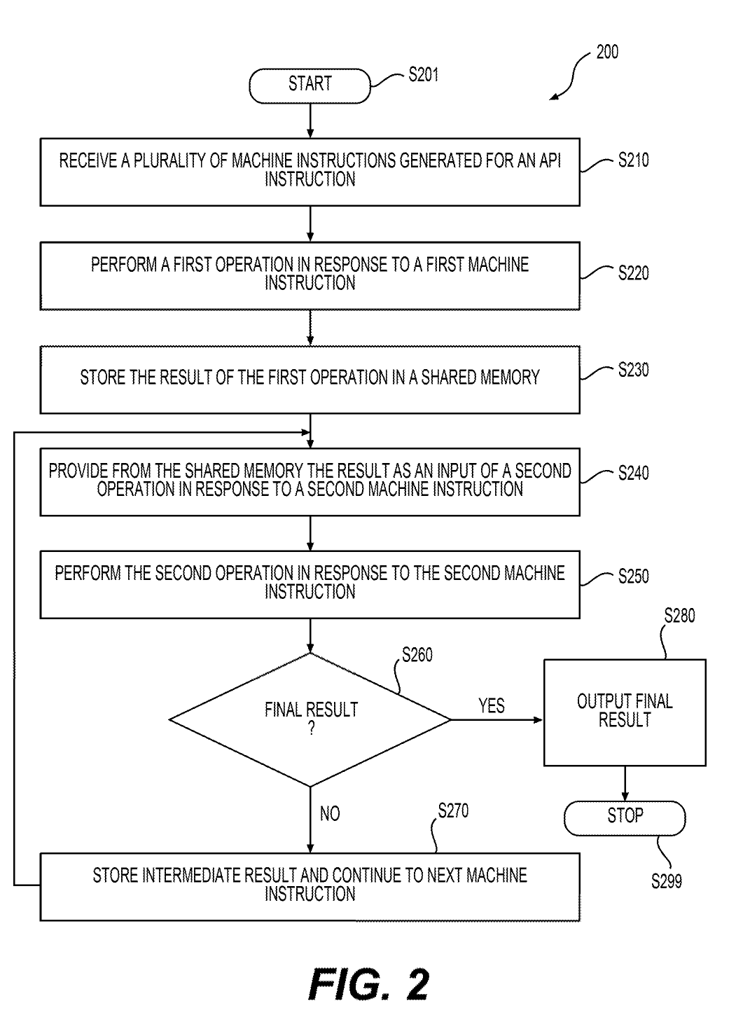

FIG. 2 shows a flow chart outlining a process example 200 according to an embodiment of the disclosure. In an example, the process 200 is executed by the texture processor 120 in the FIG. 1 example. The process starts at S201 and proceeds to S210.

At S210, a plurality of machine instructions are received. In an example, the plurality of machine instructions are generated in response to an API instruction in high level programming language. For example, an application of artificial intelligence includes API instructions, such as a convolution API instruction, a matrix multiplication API instruction it high level programming language. The API instruction includes calculations in a relatively large scale, such as a relatively large kernel (e.g., the number of elements in the kernel is larger than four) in convolution, relatively, large matrices in matrix multiplication, and the like. In an example, the processor 102 executes the instructions 104 of the compiler to translate API instructions from the high level programing language to a low level language, such as machine instructions that are executable by the texture processor 120. In the example, the processor 102 generates a plurality of machine instructions in response to an API instruction. In an example, the plurality of machine instructions include calculation instructions (e.g., convolution instruction, matrix multiplication instruction), and data transfer instructions (e.g., load instruction, store instruction). The plurality of machine instructions are loaded in the instruction cache 111. The instruction scheduler 112 then provides the scheduled machine instructions to the texture processor 120.

At S220, a first operation (e.g., an atomic operation) that includes dot product calculation is performed in response to a first machine instruction. In an example, the control circuit 170 receives the first machine instruction, and generates the control signals to control the components of the texture processor 120 to perform the operation. In an example, the first machine instruction is a convolution machine instruction, and the texture processor 120 performs a convolution operation that includes dot product calculations. In another example, the first machine instruction is a matrix multiplication machine instruction, and the texture processor 120 performs a matrix multiplication operation that includes dot product calculations. The dot product calculations are performed by the DP engine 160 for example.

At S230, the result of the first operation is stored in a shared memory. In the FIG. 1 example, the result of the first operation is an intermediate result for the API instruction, and is stored in the shared memory 180.

At S240, the result is provided from the shared memory as an input of a second operation in response to a second machine instruction. In the FIG. 1 example, the shared memory 180 can provide weights to the weight circuits and can provide accumulation matrix input to the DP engine 160.

At S250, a second operation is performed in response to the second machine instruction. In an example, the second operation is an atomic operation that includes a dot product calculation that is performed by the DP engine 160.

At S260, when the final result of the plurality of machine instructions is obtained, the process proceeds to S280; otherwise the process proceeds to S270.

At S270, the result of the second machine instruction is stored in the shared memory as intermediate result, and the process continues to a next machine instruction. For example, the process returns to S240 to provide, from the shared memory, input for the next machine instruction.

At S280, the final result is output, for example, to the shades processor 110. Then tine process proceeds to S299 and terminates.

FIG. 3 shows a diagram of an input-output correspondence configuration 300 for a convolution machine instruction according to an embodiment of the disclosure, In an example, when the texture processor 120 receives a convolution machine instruction, the control circuit 170 controls the components in the texture processor 120 to have the input-output correspondence configuration 300.

According to an aspect of the disclosure, the texture processor 120 performs texture filtering; operation in response to a texture filtering machine instruction. During the texture filtering operation, in an example, the texture address generator 140 calculates weights (filtering coefficients) for four pixels (e.g., a first pixel, a second pixel, a third pixel and a fourth pixel) from the texture filtering instruction based on fractional parts of texture coordinates, and provides the weights to the weight circuit 150. The weight circuit 150 provides the weights as inputs, for example in the form of a weight matrix 350, to the DP engine 160, The weight matrix 350 includes four columns 351-354 respectively for the four pixels. For example, the column 351 includes filtering, weights for the first pixel, the column 352 includes filtering weights for the second pixel, the column 353 includes filtering weights for the third pixel, and the column 354 includes filtering weights for the fourth pixel.

Further, in the example, in response to the texture filtering instruction, for each pixel, the texture address generator 140 determines positions of pixel samples (e.g., four pixel samples) for filtering, and provides the positions of the pixel samples to the texture cache 145. In an embodiment, the texture cache 145 provides pixel samples as inputs, for example in the form of A matrix 310, R matrix 320, G matrix 330 and B matrix 340, to the DP engine 160.

The A matrix 310 includes four rows 311-314 respectively for the four pixels. For example, the row 311 includes alpha values of the four pixel samples for the first pixel; the row 312 includes alpha values of the four pixel samples for the second pixel; the row 313 includes alpha values of the four pixel samples for the third pixel; and the row 314 includes alpha values of the four pixel samples for the firth pixel.

The R matrix 320 includes four rows 321-324 respectively for the four pixels. For example, the row 321 includes red values of the four pixel samples for the first pixel; the row 322 includes red values of the four pixel samples for the second pixel; the row 323 includes red values of the four pixel samples for the third pixel; and the row 324 includes red values of the four pixel samples for the fourth pixel.

The G matrix 330 includes four rows 331-334 respectively for the four pixels. For example, the row 331 includes green values of the four pixel samples for the first pixel; the row 332 includes green values of the four pixel samples for the second pixel; the row 333 ludes green values of the four pixel samples for the third pixel; and the row 334 includes green values of the four pixel samples for the fourth pixel.

The B matrix 340 includes four rows 341-344 respectively for the four pixels. For example, the row 341 includes blue values of the four pixel samples for the first pixel; the row 342 includes blue values of the four pixel samples for the second pixel; the row 343 includes blue values of the four pixel samples for the third pixel; and the row 344 includes blue values of the four pixel samples for the fourth pixel.

In an embodiment, the DP engine 160 includes a plurality of DP circuits, such as sixteen DP circuits D1-D16. Each of the DP Circuits D1-D16 operates similarly to a DP circuit 370 shown in FIG. 3. The DP circuit 370 receives a first input I1 (e.g., a vector, a sequence of numbers of a specific length) and, a second input I2 of the same length as the first input I1, and calculates for example dot product (also referred to as scalar product, inner product, projection product), and outputs a number P. In an example, the DP circuit 370 is a DP circuit of four dimensions, thus the first input I1 and the second input I2 have the same length of four.

In the example of the texture filtering operation, the ARGB matrices 310-350 and the weight matrix 350 form the inputs to the DP circuits D1-D16, and the outputs P from the DP circuits D1-D16 form a matrix 360. Specifically, in an, example, the rows 311-314 respectively form the first input I1 to the DP circuits D1-D4, the rows 321-324 respectively form the first input I1 to the DP circuits D5-D8, the rows 331-334 respectively form the first input I1 to the DP circuits D9-D12, the rows 341-344 respectively form the first input I1 to the DP circuits D13-D16. In the example, the column 351 forms the second input I2 to the DP circuits D1, D5, D9 and D13; the column 352 forms the second input I2 to the DP circuits D2, D6, D10 and D14; the column 353 forms the second input I2 to the DP circuits D3, D7, D11 and D15; the column 354 forms the second input I2 to the DP circuits D4, D8, D12 and D16.

In an example, the outputs of the DP circuits D1-D16 form the matrix 360. The matrix 360 can be added with another input matrix (accumulation input matrix) to the DP engine 160. In the FIG. 3 example, the DP engine 160 includes a plurality of accumulation circuits, such as 16 accumulation circuits. Each of the accumulation circuits operates similarly to an accumulation circuit 380 shown in FIG. 3. The accumulation circuit 380 receives an output P of a DP circuit, and a second input M which can be an element of the other input matrix (accumulation input matrix) to the DP engine 160, and adds the two inputs to generate an output O. In an embodiment, the accumulation circuit 380 is implemented with a relatively higher precision. In an example, the accumulation circuit 380 is reconfigured from a previous accumulation circuit for texture filtering to increase precision. For example, the previous accumulation circuit has a precision of 16 bits, and the accumulation circuit 380 is reconfigured to have a precision of 32 bits.

In an example, the outputs of the accumulation circuits form an output matrix of the DP engine 160, which is the result of the texture filtering instruction.

According to an aspect of the disclosure, in an application using artificial intelligence, a relatively large convolution kernel (e.g., more than four elements) is used. In an example, the application includes a convolution API instruction in a high level language. The application is compiled, and a plurality of convolution machine instructions and data transfer machine instructions (e.g., load machine instructions, store machine instructions) that are executable by the texture processor 120 are generated in response to the convolution API instruction. In an example, the convolution kernel is partitioned into smaller portions that are executable by the DP circuits in the texture processor 120. In an embodiment, the convolution kernel is partitioned during compilation. For example, the processor 102 executes the software instructions 104 to generate machine instructions respectively for the smaller portions. The machine instructions are executable by the DP circuits in the texture processor 120.

In another embodiment, the texture address generator 140 is configured to generate multiple atomic instructions respectively for the smaller portions. The atomic instructions are executable by the DP circuits in the texture processor 120.

In the FIG. 3 example, a large kernel 390 is split into smaller portions, such as portions 391 and 392 of 2×2, of four elements. In an example, at the boundary a part 393 can be combined with another part 394 to have four elements. In another example, dummy elements (e.g., with zero value) can be added at the boundary to make the large kernel 390 to be partitioned into 2×2 portions.

In an embodiment, based on the partitions, convolution machine instructions can be generated. In an example, a convolution machine instruction includes four parameters, such as a destination, a weight, a texture and an accumulation. The weight is indicative of memory location for the weight matrix 350, the texture is indicative of memory location for the ARGB matrices 310-340, the accumulation is indicative of memory location for the accumulation input matrix, and the destination is indicative of memory location for the output matrix. In an embodiment, by suitably constructing the weight matrix 350 and the ARG matrices 310-340, the convolution machine instruction is executed using the same hardware configuration (e.g., DP engine 160) as the texture filtering machine instruction.

In an example, the output matrix of the convolution machine instruction is an intermediate result for the convolution API instruction. The intermediate result is stored in the shared memory 180. Additionally, data transfer machine instructions are suitably generated to combine the convolution results of the partitions. In an example, load machine instructions can be generated to load the convolution kernel 390 in the shared memory 180 for fast access speed. In another example, load machine instructions can be generated to load an intermediate result from the shared memory 180 to the DP engine 160 for example as the accumulation input matrix. In an example, the mix of convolution machine instructions and the data transfer machine instructions can cause the texture processor 120 and the shared memory 180 to operate cooperatively to accumulate the intermediate results to generate a final result for the convolution API instruction. The final result is then output to the shader processor 110. In an example, the intermediate results are not provided to the shader processor 110.

It is noted that the input-output correspondence configuration 300 is an example, and can be suitably modified.

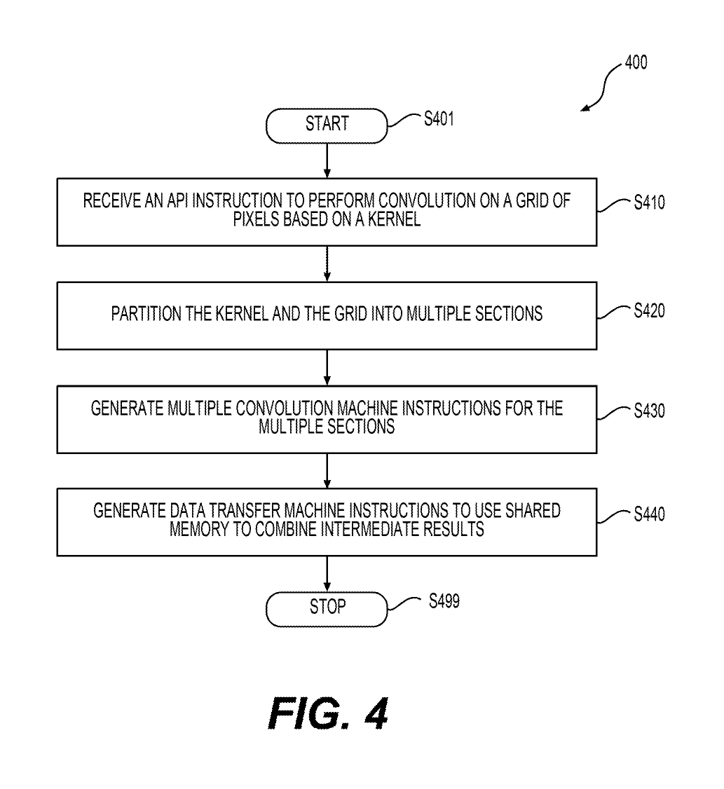

FIG. 4 shows a flow chart outlining a process example 400 according to an embodiment of the disclosure. In an example, the process 400 is executed by the processor 102 for compilation. For example, an application of artificial intelligence includes API instructions in high level programming language. The processor 102 executes the software instructions of the compiler 104 to translate the API instructions from the high level programing language to low level languages, such as machine instructions that are executable by the shader processor 110 and the texture processor 120. The process starts at S401 and proceeds to S410.

At S410, an API instruction to perform convolution on a grid of pixels based on a kernel is received. In an example, the API instruction is one of the API instructions in the high level programing language.

At S420, the kernel is partitioned into multiple sections. For example, the kernel 390 is partitioned into sections of four elements, such as 2×2 sections.

At S430, multiple convolution machine instructions are generated for the multiple sections. In an example, the convolution machine instructions store results in a shared memory, such as the shared memory 180, as intermediate results.

At S440, data transfer machine instructions (load machine instructions) that use the shared memory to combine the intermediate results of the convolution machine instructions are generated. Then the process proceeds to S499 and terminates.

FIG. 5 shows a diagram of an input-output correspondence configuration 500 for a matrix multiplication machine instruction according to an embodiment of the disclosure. In an example, when the texture processor 120 receives a matrix multiplication machine instruction, the control circuit 170 controls the components in the texture, processor 120 to have the input-output correspondence configuration 500.

According to an aspect of the disclosure, in an application using artificial intelligence, multiplications of relatively large matrices (e.g., larger than 4×4) are used. In an example, the application includes a matrix multiplication API instruction in a high level language. The application is compiled, and a plurality of matrix multiplication machine instructions and data transfer machine instructions (e.g., load machine instructions, store machine instructions) that are executable by the texture processor 120 are generated in response to the matrix multiplication API instruction. In an example, the matrices are partitioned into smaller portions, such as 4×4, that are executable by the DP circuits in the texture processor 120.

In the FIG. 5 example, a DP engine, such as the OP engine 160, is wired to have the input-output correspondence configuration 500. For example, inputs and outputs of the OP circuits are wire-connected to the weight circuit 150, the texture cache 145 and the shared memory 180 according to the input-output correspondence 500. In an example, the DP circuits in the DP engine 160 has a first wiring configuration corresponding to the, input-output correspondence configuration 300, and a second wiring configuration corresponding to the input-output correspondence configuration 500. The control circuit 170 provides the control signals in response to the received machine instruction to switch the DP engine 160 to one of the wiring configurations. For example, when the received machine instruction is a texture filtering machine instruction or a convolution machine instruction, the control circuit 170 provides the control signals to switch the DP engine 160 to have the first wiring configuration; and when the received instruction is a matrix multiplication machine instruction, the control circuit 170 provides the control signals to switch the DP engine 160 to have the second wiring configuration.

In the FIG. 5 example, the weight circuit 150 provides the weights as inputs, for example in the form of a weight matrix 550, to the DP engine 160. The weight matrix 550 includes four columns 551-554. The texture cache 145 provides a matrix 520. The matrix 520 includes four rows 521-524.

In an embodiment, the DP engine 1.60 includes a plurality of DP circuits, such as sixteen DP circuits D1-D16. Each of the DP circuits D1-D16 operates similarly to a DP circuit 570 shown in FIG. 5. The DP circuit 570 receives a first input I1 (e.g., a vector, a sequence of numbers of a specific length) and a second input I2 of the same length as the first input I1, and calculates for example dot product, and outputs a number P. In an example, the DP circuit 570 is a DP circuit of four dimensions, thus the first input I1 and the second input I2 have the same length of four.

In the example of the matrix multiplication operation, the matrix 520 and the weight matrix 550 form the inputs to the DP circuits D1-D16, and the outputs P from the DP circuits D1-D16 form a matrix 560. Specifically, in an example, the row 521 forms the first input I1 respectively to the OP circuits D1, D5, D9 and D13, the row 522 forms the first input I1 respectively to the DP circuits D2, D6, D10 and D14, the row 523 forms the first input I1 respectively to the DP circuits D3, D3, D12 and D15, the row 524 forms the first input I1 respectively to the DP circuits D4, D8, D12 and D16. In the example, the column 551 forms the second input I2 to the DP circuits D1-D4; the column 552 forms the second input 12 to the DP circuits D5-D8; the column 553 forms the second input I2 to the DP circuits D9-D12; the column 554 forms the second input I2 to the DP circuits D13-D16.

In an example, the outputs of the DP circuits D1-D16 form the matrix 560. The matrix 560 can be added with another input matrix (accumulation input matrix) to the DP engine 160. In the FIG. 5 example, the DP engine 160 includes a plurality of accumulation circuits, such as 16 accumulation circuits. Each of the, accumulation circuits operates similarly to an accumulation circuit 580 shown in FIG. 5. The accumulation circuit 580 receives an output P of a DP circuit, and a second input M which can be an element of the other input matrix (accumulation input matrix) to the DP engine 160, and adds the two inputs to generate an output O.

In an example, the outputs of the accumulation circuits form an output matrix of the DP engine 160, which is the result to the matrix multiplication machine instruction.

FIG. 6 shows a diagram of an input-output correspondence configuration 600 for a matrix multiplication machine instruction according to another embodiment of the disclosure. In an example, when the texture processor 120 receives a matrix multiplication machine instruction, the control circuit 170 controls the components in the texture processor 120 to have the input-output correspondence configuration 600.

According to an aspect of the disclosure, in an application using artificial intelligence, multiplications of relatively large matrices (e.g., larger than 4×4) are used. In an example, the application includes a matrix multiplication API instruction in a high level language. The application is compiled, and a plurality of matrix multiplication machine instructions and data transfer, machine instructions (e.g., load machine instructions, store machine instructions) that are executable by the texture processor 120 are generated in response to the matrix multiplication API instruction. In another example, the matrices are partitioned into smaller portions, such as 4×4, that are executable by the DP circuits in the texture processor 120.

In the FIG. 6 example, a DP engine, such as the DP engine 160, is wired similarly to the input-output correspondence configuration 300. The inputs and the outputs are shuffled (e.g., arranged), such that the DP circuits in the DP engine 160 can perform dot product calculations for matrix multiplication.

In an example, the control circuit 170 provides the control signals in response to the received machine instruction to shuffle the inputs and the outputs of the DP engine 160. For example, when the received machine instruction is a convolution machine instruction, the control circuit 170 provides the control signals to shuffle the inputs and the outputs according to the input-output correspondence configuration 300; and when the received instruction is a matrix multiplication machine instruction, the control circuit 170 provides the control signals to shuffle the inputs and the outputs according to the input-output correspondence configuration 600.

In the FIG. 6 example, the texture processor 120 performs a matrix multiplication of a first matrix 601 and a second matrix 650. The second matrix 650 is provided to the DP engine 160 by the weight circuit 150 as a weight matrix 650 in the same manner as in the FIG. 3 example, the description has been provided above and will be omitted here for clarity purposes. The first matrix 601 is re-arranged to generate ARGB matrices 610-640. In an embodiment, the first matrix 601 includes four rows row1-row4, the four rows, are shifted to form the ARGB matrices 610-640.

In the FIG. 1 example, the A matrix 610 includes the four rows in the sequence of row1, row2, row3 and row4. The R matrix 620 includes the four rows in the sequence of row2, row3, row4 and row1. The G matrix 630 includes the four rows in the sequence of row3, row4, rowl and row2. The B matrix 340 includes the four rows in the sequence of row4, row1, row2 and row3.

Similarly to the embodiment in FIG. 3, the DP engine 160 includes a plurality of DP circuits, such as sixteen DP circuits D1-D16. Each of the DP circuits D1-D16 operates similarly to a DP circuit 670 shown in FIG. 6 The DP circuit 670 receives a first input I1 (e.g., a vector, a sequence of numbers of a specific length) and a second input I2 of the same length as the first input I1, and calculates for example dot product, and output a number P. In an example, the DP circuit 670 is a DP circuit of four dimensions, thus the first input I1 and the second input I2 have the same length of four.

Similarly to the embodiment in FIG. 3, the ARCM matrices 610-650 and the weight matrix 650 form the inputs to the DP circuits D1-D16, and the outputs P from the DP circuits D1-D16 form a matrix 660. Specifically, in an example, the rows 611-614 respectively form the first input I1 to the DP circuits D1-D4, the rows 621-624 respectively form the first input I1 to the DP circuits D5-D8, the rows 631-634 respectively form the first input I1 to the DP circuits D9-D12, the rows 641-644 respectively form the first input I1 to the DP circuits D13-D16. In the example, the column 651 forms the second input I2 to the DP circuits D1, D5, D9 and D13; the column 652 forms the second input I2 to the DP circuits D2, D6, D10 and D14; the column 653 forms the second input I2 to the DP circuits D3, D7, D11 and D15; the column 654 forms the second input I2 to the DP circuits D4, D8, D12 and D16.

In an example, the outputs of the DP circuits D1-D16 form the matrix 660. It is noted that elements in the matrix 660 are shuffled, and are arranged differently from the matrix 360. The matrix 660 can be added with another input matrix (accumulation input matrix) to the DP engine 160. In the FIG. 6 example, the DP engine 160 includes a plurality of accumulation circuits, such as 16 accumulation circuits. Each of the accumulation circuits operates similarly to an accumulation circuit 680 shown in FIG. 6. The accumulation circuit 680 receives an output P of a DP circuit, and a second input M which can be an element of the other input matrix (accumulation input matrix) to the DP engine 160, and adds the two inputs to generate an output O.

In art example, the outputs of the accumulation circuits form an output matrix of the DP engine 160, which the result to the matrix accumulation machine instruction.

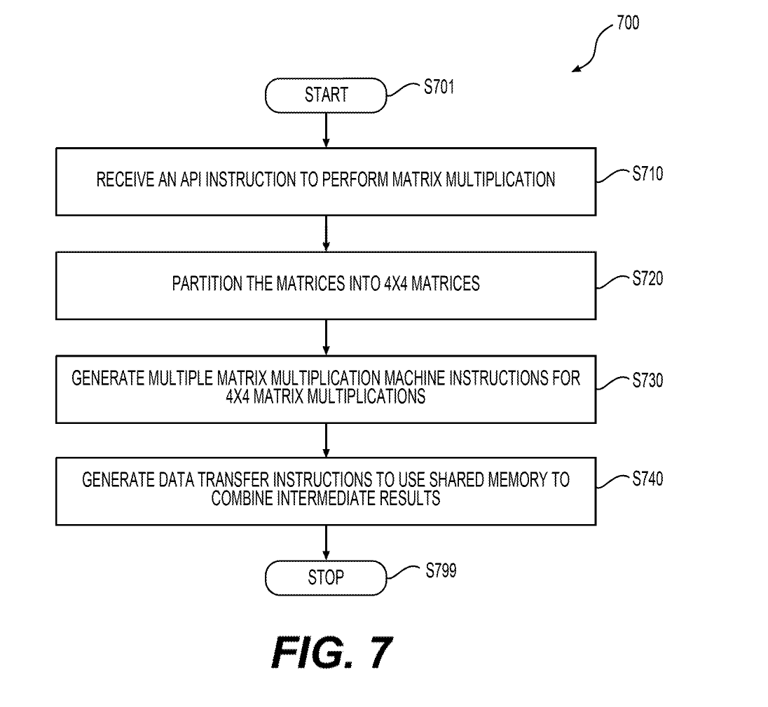

FIG. 7 shows a flow chart outlining a process example 700 according to an embodiment of the disclosure. In an example, the process 700 is executed by the processor 102 for compilation. For example, an application of artificial intelligence includes API instructions in high level programming language. The processor 102 executes the software instructions of the compiler 104 to translate the API instructions from the high level programing language to low level languages, such as machine instructions that are executable by the shader processor 110 and the texture processor 120. The process starts at S701 and proceeds to S710.

At S710, an API instruction to perform matrix multiplication is received. In an example, the API instruction is one of the API instructions in the high level programing language.

At S720, the matrices are partitioned into multiple sections. For example, the matrices are partitioned into 4×4 sections,

At S730, multiple matrix multiplication machine, instructions are generated for the multiple sections. In an example, the matrix multiplication machine instructions store results in a shared memory, such as the shared memory 180, as intermediate results.

At S740, data transfer machine instructions (load machine instructions and store machine instructions) that use the shared memory to combine the intermediate results of the matrix multiplication machine instructions are generated. Then the process proceeds to S799 and terminates.

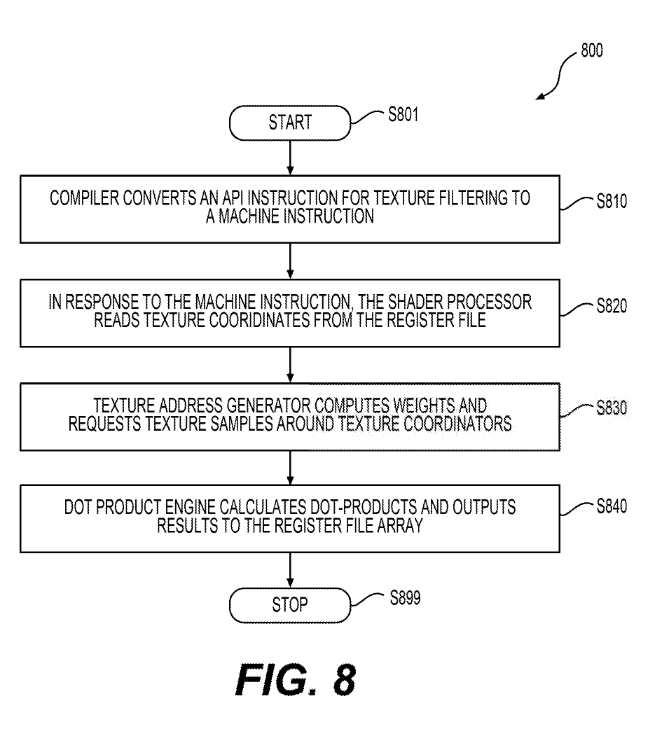

FIG. 8 shows a flow chart outlining a process example 800 of texture filtering that is executed in the electronic device 100 according to an embodiment of the disclosure. The process starts at S801 and proceeds to S810.

At S810, a compiler converts an API instruction for texture filtering to a machine instruction for texture filtering, in an example, the API instruction for texturing filtering has a syntax as shown in Eq. 2:

Result.destID.loc=texture (texCoord, texImage, filterMode) Eq. 2

where Result.destID.loc is indicative of a memory device (e.g., shared memory 180, the register file array 114 and the like) and address in the memory device to store the result of the API instruction: texCoord is indicative of one or more registers in the register file array 114 where one or more texture coordinates are stored; texImage is a descriptor that specifies attribute of the texture image, such as the texture image memory location, format and texture image dimension size and the like; filterMode is a descriptor which specifies filtering mode such, as bilinear filtering, trilinear filtering or other modes. In an example, texCoord is indicative of one register in the register file array 114 where a texture coordinate (u,v) is stored. In another example, texCoord is indicative of four registers in the register file array 114 where four texture coordinates are stored.

In an example, the processor 102 executes the software instructions of the compiler 104 to compile, for example, the API instruction Eq. 2 and generates a machine instruction in binary. The machine instruction far the texture filtering is indicative of texturing filtering, and identifiers of registers that store the texture coordinates in a texture space.

At S820, the shader processor 110 receives the machine instruction for the texture filtering and decodes the machine instruction. In an example, the instruction scheduler 112 schedules the machine instruction for the texture filtering to be executed by the texture processor 120. For example, instruction scheduler 110 reads the texture coordinates from identified registers in the register file array 114 according to the machine instruction, and provides the texture coordinates and the machine instruction to the texture processor 120.

At S830, the texture address generator 140 calculates filtering coefficients (e.g., 4 coefficients for a 2×2 grid) based on each texture coordinate, and provides the filtering coefficients to the weight circuit 150 as weights. Further, in response to the machine instruction, the texture address generator 140 determines positions of pixel samples (e.g., four pixel samples for each texture coordinate) for filtering, and provides the positions of the pixel samples to the texture cache 145.

At S840, the DP engine 160 calculates dot products and outputs results to the register file allay 114. In an example, the weight circuit 150 provides weights in the form of the weight matrix 350, and the texture cache 145 provides pixel samples in the form of the ARGB matrices 310, 320, 330 and 340, and the DP engine 160 calculates the dot product operations according to Eq. 1 and outputs results (e.g., in the form of a matrix) to the register file array 114. Further, the results are stored in the memory space indicated by Result.destID.loc. Then the process proceeds to S899 and terminates.

It is noted that, in an example, each machine instruction for texture filtering is indicative of one texture coordinate, the instruction schedule 112 can schedule multiple machine instructions for the DP engine 160 to execute at the same time.

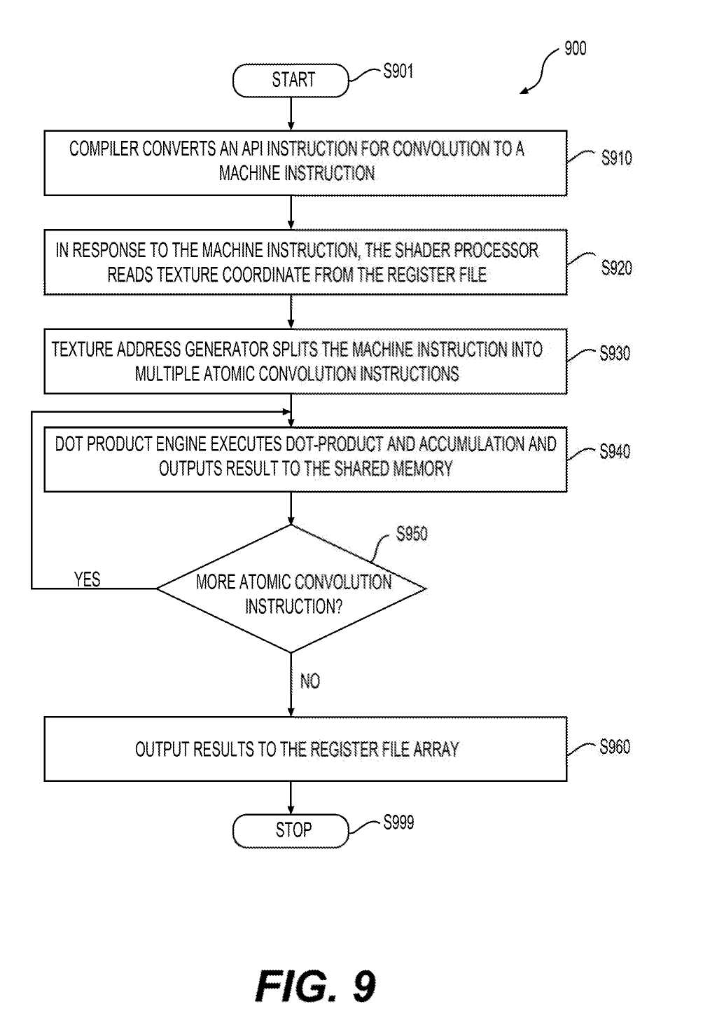

FIG. 9 shows a flow chart outlining, a process example 900 of convolution that is executed by the electronic device 100 according to an embodiment of the disclosure. The process starts at S901 and proceeds to S910.

At S910, a compiler converts an API instruction for convolution to a machine instruction for convolution. In an example, the API instruction for convolution has a syntax as, shown in Eq. 3:

Result.destID.loc=convolve (texCoord, texImage, kernel) Eq. 3

where Result.destID.loc is indicative of a memory device (e.g., shared memory 180, the register file array 114 and the like) and address in the memory device to store the result of the API instruction; texCoord is indicative of a register in the register file array 114 where a texture coordinate is stored; texImage is a descriptor that specifies attribute of the texture image, such as the texture image memory location, format and texture image dimension size and the like; kernel is a descriptor that specifies convolution kernel attributes, such as kernel size, identifier of a memory device (e.g., the main memory 107, the shared memory 180, or the register file array 114) for storing convolution kernel weight, and the like.

In an example, the processor 102 executes the software instructions 104 of the compiler to compile the API instruction Eq. 3 and generates a machine instruction in binary. The machine instruction for convolution is indicative of convolution, an identifier of a register that stores the texture coordinate in a texture space, and the kernel.

At S920, the shader processor 110 receives the machine instruction for convolution and decodes the machine instruction. The instruction scheduler 112 schedules the machine instruction for convolution to be executed by the texture processor 120. For example, instruction scheduler 110 reads the texture coordinate from the identified register in the register file array 114 according to the machine instruction, and provides the texture coordinate and the machine instruction to the texture processor 120.

At S930, the texture address generator 140 generates multiple atomic convolution instructions in response to the machine instruction for convolution. In an example, the kernel has a size of 5×5, and the texture address generator 140 splits the kernel for example into seven portions that each portion has equal or less than 4 elements. Further, the texture address generator 140 generates seven atomic convolution instructions in response to the machine instruction for convolution. In the example, each of the atomic convolution instructions specifies a convolution operation that uses one of the seven portions of the kernel.

At S940, the DP engine 160 calculates dot, product in response to an atomic convolution instruction. The DP engine 160 can accumulate the output of the dot product with previous result of a previous atomic convolution instruction to generate a present result, and store the present result into the shared memory 180.

At S950, when pending atomic convolution instruction exists, the process returns to S940 for the DP engine 160 to execute a next atomic convolution instruction; otherwise the process proceeds to S960.

At S960, the final result is output to the register file array 114 identified by Result.destID.loc. Then the process proceeds to S999 and terminates.

It is noted that, in an example, each machine instruction for convolution is indicative of one texture coordinate, the instruction schedule 112 can schedule multiple (e.g., 16) machine instructions of convolution (e.g., using the same kernel) for the DP engine 160 to execute at the same time. In an example, at S940, the, weight circuit 150 suitably provides weights in the form of the weight matrix 350 based on one or more portions of the kernel, and the texture cache 145 provides pixel samples for multiple texture coordinates (e.g., 16) in the form of the ARGB matrices 310, 320, 330 and 340, and the DP engine 160 calculates dot product operations for the multiple machine instructions at the same time. The DP engine 160 can accumulate the outputs of the dot product calculations with previous results to generate present results (e.g., in the form of a matrix) and store the present results in the shared memory 180.

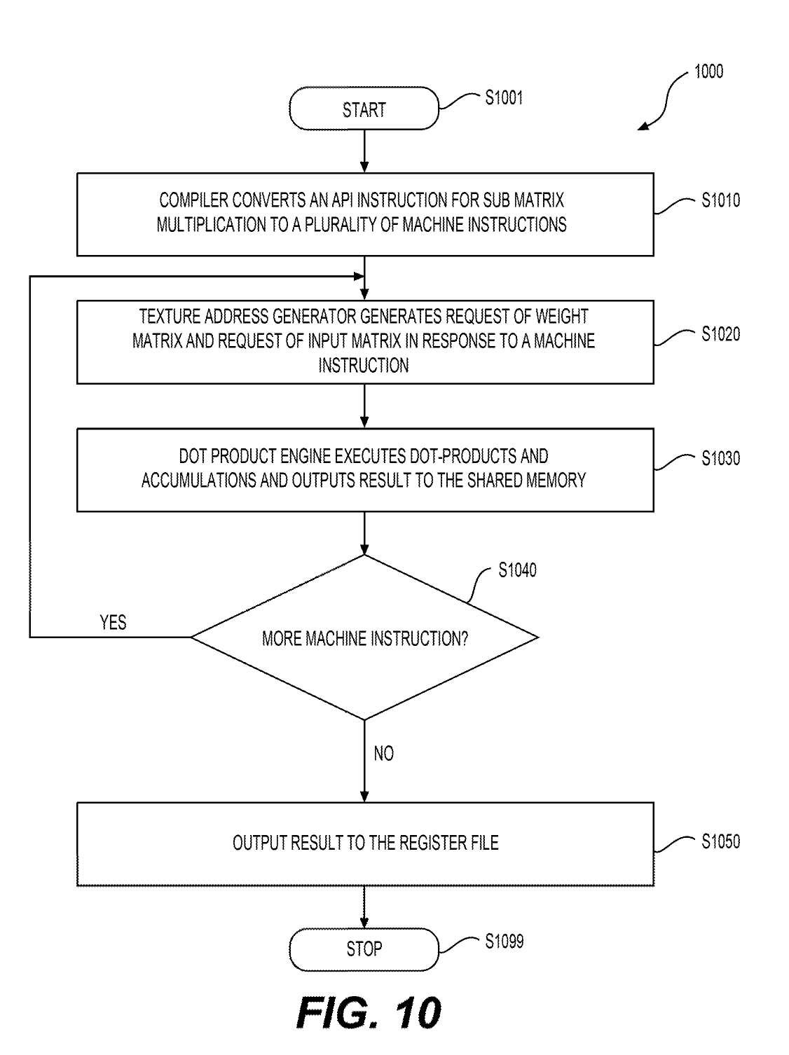

FIG. 10 shows a flow chart outlining a process example 1000 that is executed by the electronic device 100 according to an embodiment of the disclosure. The process starts at S1001 and proceeds to S1010,

At S1010, a compiler converts an API instruction for sub matrix multiplication to a plurality of machine instructions for matrix multiplication. In an example, the API instruction for sub matrix multiplication has a syntax as shown in Eq. 4:

Result.destID.loc=MatrixMultiply (weightCoord, weightMatrix, inputCoord, inputMatrix, accumM) Eq. 4

where Result.destID.loc is indicative of a memory device (e.g., shared memory 180, the register file array 114 and the like) and address in the memory device to store the result of the API instruction; weightCoord is indicative of a starting coordinate of a sub weight matrix relative to the original weight matrix; weightMatrix is a descriptor that specifies attribute of the weight matrix, such as the data precision, format, identifier of a memory device, starting address of the original weight matrix; inputCoord is indicative of a starting coordinate of a sub input matrix relative to the original input matrix; inputMatrix is a descriptor that specifies attribute of the input matrix, such as the data precision, format, identifier of a memory device, starting address of the original input matrix; and accumM is indicative of memory space storing intermediate results to be combined with the present matrix multiplication of sub weight matrix and sub input matrix.

In an example, an application includes a matrix multiplication of a weight matrix and an input matrix. The weight matrix and the input matrix are relatively large, such as in a size over 100×100. The weight matrix is split into sub weight matrices of relatively small size, such as 8×8, and the input matrix is split into sub weight matrices of relatively small size, such as 8×8. The application then includes a plurality of API instructions for sub matrix multiplication in the syntax of Eq. 4.

In an example, the processor 102 executes the software instructions 104 of the compiler to compile the API instruction in the syntax of Eq. 4 and generates a plurality of machine instructions of matrix multiplication in binary. For example, the sub weight matrix and the sub input matrix are further partitioned into multiple sections, such as 4×4 sections. Then, in an example, each machine instruction of matrix multiplication specifies a 4×4 matrix multiplication.

At S1020, the shades processor 110 receives a machine instruction for matrix multiplication and decodes the machine instruction. The instruction: scheduler 112 schedules the machine instruction for matrix multiplication to be executed by the texture processor 120. In an example, the texture address generator 140 generates requests for the matrix 520 and the weight matrix 550 (or the first matrix 601 and the second matrix 650) in response to the machine instruction. In an example, the weight matrix 550 is provided by the weight circuit 150, and the matrix 520 is provided by the texture cache 145.

At S1030, the DP engine 160 performs dot product calculations of the matrix multiplication and accumulates present outputs of dot product calculations with previous result to generate a present result. The present result is stored into the shared memory 180.

At S1040, when there exists pending machine instruction of matrix multiplication, the process returns to S1020; otherwise the process proceeds to S1060.

At S1050, the final result is output to the register file array 114 identified by Result.destID.loc. Then the process proceeds to S1099 and terminates.

When implemented in hardware, the hardware may comprise one or more of discrete components, an integrated circuit, an application-specific integrated circuit (ASIC), etc.

While aspects of the present disclosure have been described in conjunction with the specific embodiments thereof that are proposed as examples, alternatives, modifications, and variations to the examples may be made. Accordingly, embodiments as set forth herein are intended to be illustrative and, not limiting. There are changes that may be made without departing from the scope of the claims set forth below.

What is claimed is:

1. A circuit, comprising:
a processing circuit including a dot product engine, the dot product engine being configured to perform, in response to an instruction, an operation that includes dot product calculations on a weight input and a pixel sample input, and to store a result of the operation into a memory;
the memory directly coupled to the processing circuit via a dedicated data bus; and
a control circuit configured to:
control the dot product engine to perform arithmetic operations that include the dot product calculations; and
control the dot product engine to perform an accumulation of outputs of the dot product calculations and data received from the memory via the dedicated data bus to generate the result of the operation.

2. The circuit of claim 1, wherein the control circuit is configured to control the dot product engine to perform the accumulation of the outputs of the dot product calculations and the data received from the memory in response to at least one of a convolution application programing interface (API) instruction and a matrix multiplication API instruction.

3. The circuit of claim 1, wherein the dot product engine is configured to perform, in response to a texture filtering instruction, dot product calculations on weights and pixel samples of four dimensions for bilinear filtering.

4. The circuit of claim 3, wherein
the control circuit is configured to control the memory to provide at least one of the weights and the pixel samples.

5. The circuit of claim 4, wherein
the processing circuit further comprises:
a weight circuit configured to provide the weights to the dot product engine; and
a texture cache configured to provide the pixel samples to the dot product engine; and
the control circuit is configured to load the weights to the weight circuit from at least one of the texture cache and the memory.

6. The circuit of claim 4, wherein
the dot product engine further comprises:
at least a dot product circuit configured to calculate a dot product of four or less dimensions.

7. The circuit of claim 4, wherein the control circuit is configured to control the weights, the pixel samples and the outputs of the dot product engine to have a first input-output correspondence configuration in response to a convolution instruction, and have a second input-output correspondence configuration in response to a matrix multiplication instruction.

8. The circuit of claim 4, wherein the control circuit is configured to, have the weights, the pixel samples and the outputs shuffled according to a first input-output correspondence configuration in response to a convolution instruction, and to have the weights, the pixel samples and the outputs shuffled according to a second input-output correspondence configuration in response to a matrix multiplication instruction.

9. The circuit of claim 1, wherein
the memory comprises memory interface circuits that are directly coupled to interface circuits of the processing circuit via wire interconnections.

10. A method, comprising:
performing, by a processing circuit including a dot product engine, in response to a first instruction, a first operation that includes dot product calculations;
storing a result of the first operation in a memory that is directly coupled to the processing circuit via a dedicated data bus;
providing, from the memory, the result as an input to the processing circuit, in response to a second instruction; and
performing, by the processing circuit, a second operation that includes dot product calculations and an accumulation of outputs of the dot product calculations and the input from the memory.

11. The method of claim 10, comprising:
receiving a plurality of instructions that includes the first instruction and the second instruction, the plurality of instructions being generated in response to at least one of a convolution application programing interface (API) instruction and a matrix multiplication API instruction.

12. The method of claim 10, wherein, performing, by the processing circuit in response to the first instruction, the first operation that includes the dot product calculations comprises:
performing, by the processing circuit in response to a texture filtering instruction, dot-product calculations of four dimensions.

13. The method of claim 12, wherein providing, from the memory, the result as the input to the processing circuit, in response to the second instruction comprises:
providing at least one of weights, and pixel samples to the processing circuit from the memory. 14, The method of claim 12, comprising:
configuring the processing circuit to have a first input-output correspondence configuration in response to a convolution instruction; and
configuring the processing circuit to have a second input-output correspondence configuration in response to a matrix multiplication instruction.

15. The method of claim 12, comprising:
shuffling inputs and outputs of the processing circuit according to a first input- output correspondence configuration in response to a convolution instruction; and
shuffling the inputs and the outputs of the processing circuit according to a second input-output correspondence configuration in response to a matrix multiplication instruction.

16. A graphics processing unit, comprising:
a shader processor configured to receive a plurality of instructions, and schedule the instructions for operations;
a memory; and
a texture processor direct y coupled to the memory via a dedicated data bus, the texture processor comprising:
a dot product engine configured to perform, in response to an instruction, an operation that includes dot product calculations on a weight input and a texture input, and store a result of the operation into the memory; and
a control circuit configured to:
control the dot product engine to perform arithmetic operations that include the dot product calculations; and
control the dot product engine to perform an accumulation of outputs of the dot product calculations and data received from the memory via the dedicated data bus.

17. The graphics processing unit of claim 16, wherein the control circuit is configured to control the dot product engine to perform the accumulation of the outputs of the dot product calculations and the data received from the memory via the dedicated data bus in response to at least one of a convolution application programing interface (API) instruction and a matrix multiplication API instruction.

18. The graphics processing unit of claim 16, wherein
the control circuit is configured to control the memory to provide at least one, of weights, pixel samples, and accumulation inputs to the dot product engine.

19. The graphics processing unit of claim 16, wherein the dot product engine is configured to have a first input-output correspondence configuration in response to a convolution instruction, and have a second input-output correspondence configuration in response to a matrix multiplication instruction.

20. The graphics processing unit of claim 16, wherein the control circuit is configured to have inputs and outputs of the dot product engine shuffled according to a first input-output correspondence configuration in response to a convolution instruction, and to have the inputs and the outputs shuffled according to a second input-output correspondence configuration in response to a matrix multiplication instruction.
